(19) United States
(12) Patent Application Publication
(10) Pub. No.: US 2008/0282741 A1
(43) Pub. Date: Nov. 20, 2008

(54) PRODUCTION METHOD OF OPTICAL WAVEGUIDE

(75) Inventors: Keishi SHIMIZU, Kanagawa (JP); Akira Fujii, Kanagawa (JP); Toshihiko Suzuki, Kanagawa (JP); Kazutoshi Yatsuda, Kanagawa (JP); Shigemi Ohtsu, Kanagawa (JP); Eiichi Akutsu, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: Fuji Xerox Co., Ltd., Tokyo (JP)

(21) Appl. No.: 12/045,751

(22) Filed: Mar. 11, 2008

(30) Foreign Application Priority Data
May 17, 2007 (JP) 2007-131741

(51) Int. Cl. C03B 37/022

(52) U.S. Cl. 65/386

(57) ABSTRACT

A production method of an optical waveguide includes: preparing a laminated body that includes a first clad layer and, on the first clad layer, a core layer and a second clad layer alternately laminated in this order so that two or more of the core layer are included in the laminated body; forming a light-propagating waveguide core by cutting the laminated body so as to reach but not cut through the first clad layer from a side where the core layer and the second clad layer are laminated; and embedding at least a cut portion of the laminated body with a third clad layer.

### CROSS-REFERENCE TO RELATED APPLICATIONS

This application is based on and claims priority under 35 USC 119 from Japanese Patent Application No. 2007-131741 filed May 17, 2007.

### BACKGROUND

1. Technical Field

The present invention relates to a production method of an optical waveguide.

2. Related Art

In order to make the density of interconnections higher, not only a planar (two-dimensional) interconnection but also a three-dimensional interconnection is necessary.

### SUMMARY

According to an aspect of the invention, there is provided a production method of an optical waveguide, including: preparing a laminated body that includes a first clad layer and, on the first clad layer, a core layer and a second clad layer alternately laminated in this order so that two or more of the core layer are included in the laminated body; forming a light-propagating waveguide core by cutting the laminated body so as to reach but not cut through the first clad layer from a side where the core layer and the second clad layer are laminated; and embedding at least a cut portion of the laminated body with a third clad layer.

### BRIEF DESCRIPTION OF THE DRAWINGS

Exemplary embodiments of the present invention will be described in detail based on the following figures, wherein:

FIG. 1 is a perspective view showing an optical waveguide film according to an exemplary embodiment;

FIG. 2 is a partial sectional view showing an optical waveguide film according to an exemplary embodiment;

FIGS. 3A to 3B are perspective views showing that an optical waveguide film according to an exemplary embodiment has flexibility; and

FIGS. 4A to 4C are process charts showing a production method of an optical waveguide film according to an exemplary embodiment.

### DETAILED DESCRIPTION

In what follows, the present invention will be detailed with reference to the drawings. Members having substantially same functions and actions are given the same reference numerals through all the drawings and, in some cases, duplicated descriptions thereof will be omitted.

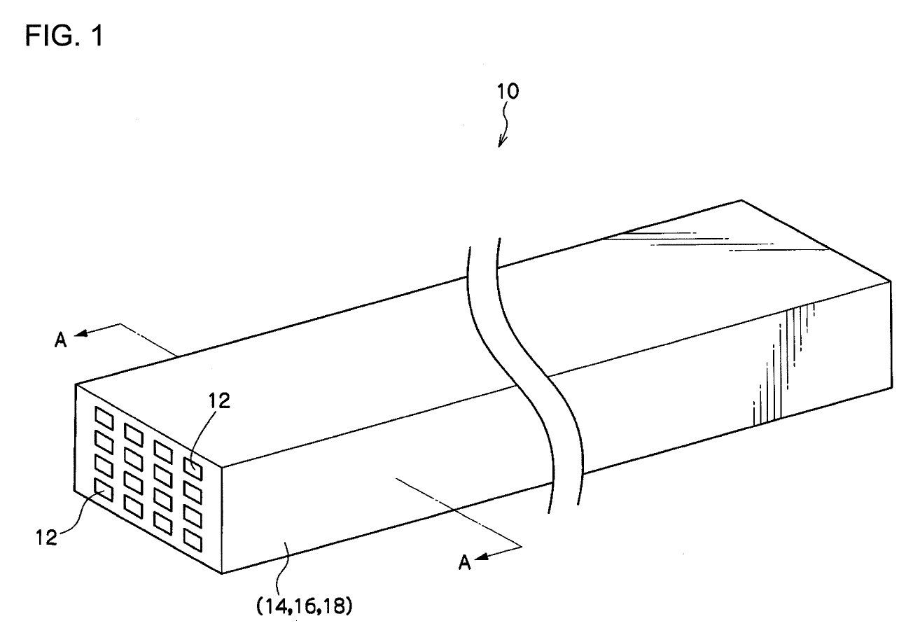

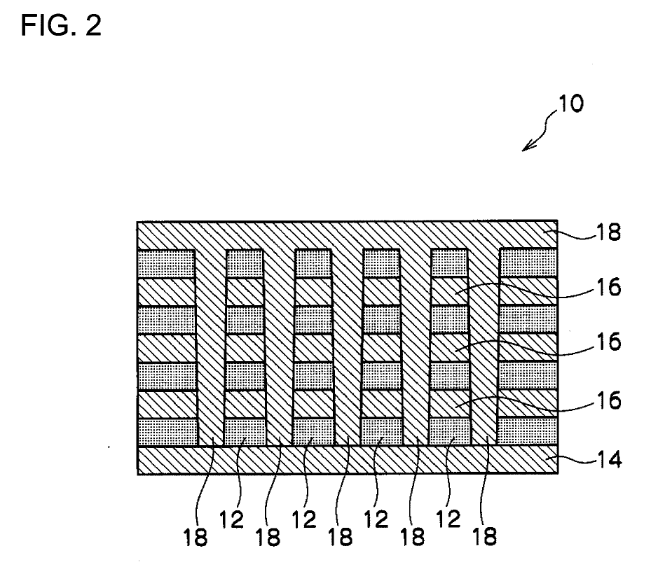

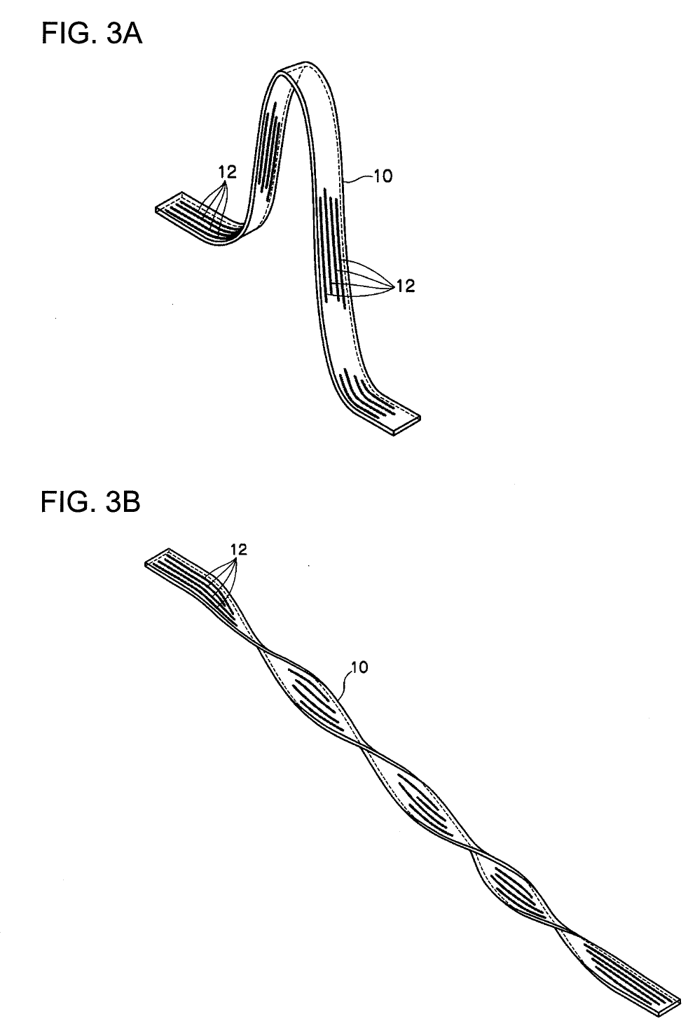

FIG. 1 is a perspective view showing an optical waveguide film according to an exemplary embodiment. FIG. 2 is a partial sectional view showing an optical waveguide film according to an exemplary embodiment. FIGS. 3A and 3B are perspective views showing that an optical waveguide film according to an exemplary embodiment has flexibility.

The optical waveguide film 10 according to the exemplary embodiment is, for example, an optical waveguide that is used in an optical interconnection and has a three-dimensional structure where waveguide cores that propagate light are arranged in array.

The optical waveguide film 10 according to the exemplary embodiment is, as shown in FIGS. 1 and 2, for instance, a long optical waveguide and has, on a first clad 14, through for instance a second clad 16 and a third clad 18, a plurality of waveguide cores 12 arranged in an array (in lattice) of n (number of waveguide cores in a direction of an optical waveguide width)×m (number of waveguide cores in a direction of an optical waveguide thickness) so that propagating lights may proceed in parallel with each other.

Here, in the exemplary embodiment, the waveguide cores 12, which have, for instance, a core diameter of 50 μm (rectangular core of 50 μm in both of width and thickness), are arranged in an array of 4×4 at a pitch of 100 μm.

The waveguide cores 12 are arranged and surrounded so that both end faces in a thickness direction thereof are covered by the second clad 16 and both end faces in the width direction thereof are covered by the third clad 18. However, among the arranged waveguide cores 12, ones positioned at both ends in a thickness direction of the optical waveguide film 10, respectively, are covered by the first clad 14 or the third clad 18 at end face sides in a thickness direction of the optical waveguide film 10.

The first clad 14, second clad 16 and third clad 18 are constituted of materials lower in the refractive index than the waveguide core 12 and in particular the refractive index difference from the waveguide core 12 may be set at 0.01 or more.

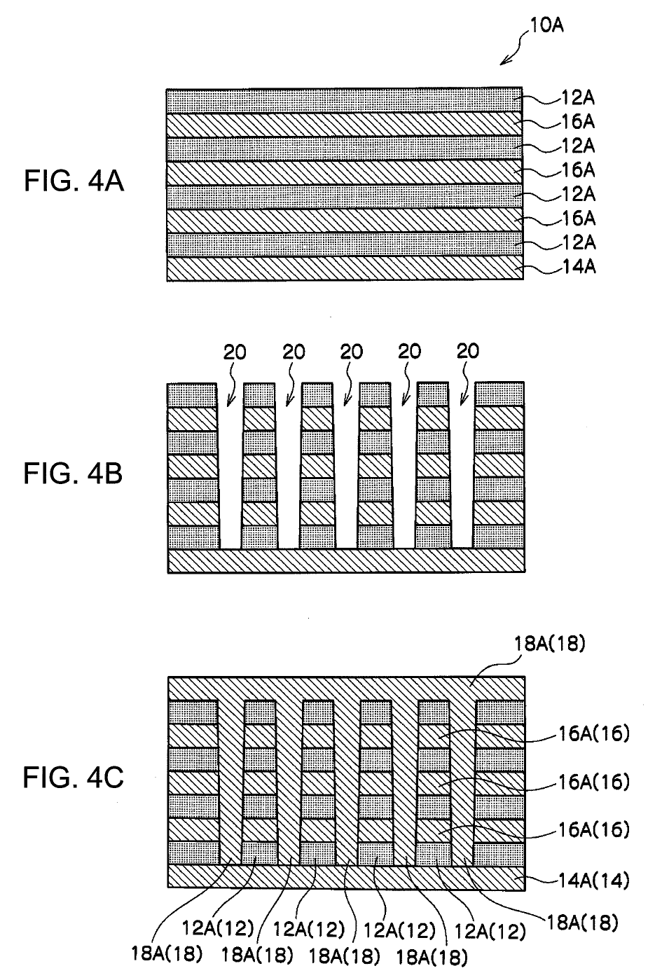

In what follows, a production method of an optical waveguide film 10 according to the exemplary embodiment will be described. FIGS. 4A to 4C are process charts showing a production method of an optical waveguide film according to the exemplary embodiment.

In the production method of the optical waveguide film 10 according to the exemplary embodiment, in the beginning, as shown in FIG. 4A, a polymer film 10A (laminated body) where a clad layer and a core layer are alternately laminated is prepared.

In the polymer film 10A, on a first clad layer 14A that corresponds to the first clad 14, a core layer 12A corresponding to a waveguide core 12 and a second clad layer 16A corresponding to the second clad 16 are alternately laminated in this order. The polymer film 10A is constituted so as to include two or more of the core layer 12A. In the exemplary embodiment, the polymer film 10A is constituted by alternately laminating four core layers 12A and three second clad layers 16A on the first clad layer 14A. That is, the polymer film 10A is constituted by alternately laminating the same number of the first clad layer 14A and second clad layers 16A and the core layers 12A (four layers in the exemplary embodiment).

In the exemplary embodiment, an embodiment in which a polymer film 10A where the lowermost layer is a clad layer (first clad layer) and the uppermost layer (an end face in a thickness direction on a side opposite to the first clad layer) is a core layer is prepared is described. However, a laminated body where both the lowermost layer and the uppermost layer are formed of a clad layer, that is, a polymer film 10A where core layers and clad layers larger in number by one than the core layers are alternately laminated (from the clad layer) may be used.

Here, the polymer film 10A is prepared by laminating sheets corresponding to the respective layers by a process such as a lamination process. The preparation of the polymer film, since there is no need of aligning the respective sheets, is simple and low in cost.

The polymer film 10A, as far as it is made of materials capable of providing a refractive index difference between the clad layer and the core layer, is not particularly restricted. Examples thereof include an alicyclic olefin film, an acrylic film, an epoxy film and a polyimide film.

In the next place, as shown in FIG. 4B, from a core layer 12A and second clad layer 16A side (an opposite side in a thickness direction of the polymer film 10A from the first clad layer 14A), the polymer film 10A is cut. Specifically, for instance, the polymer film 10A is cut so that grooves 20 (such as grooves 20 having a depth of 350 μm and a width of 50 μm: a cut portions) extending along a length direction of the film may be arranged in parallel at a predetermined separation in a film width direction.

The cutting operation is carried out so as to reach but not cut through the first clad layer 14A. The cutting operation may be carried out so as not to cut the first clad layer 14A (that is, the cutting operation is stopped when a surface of the first clad layer 14A is exposed) or so as to partially cut the first clad layer 14A but not cut through the first clad layer 14A.

Owing to the cutting, waveguide cores 12 arranged in a 4×4 array (lattice) are formed.

Here, in the exemplary embodiment, a dicing saw may be used for mechanical cutting. Cutting with a dicing saw is effective as a mechanical cutting process from the balance between the precision and the working time. It goes without saying that in the cutting, means such as reactive ion etching or excimer layer may be used.

A thickness of a blade that is used in the dicing saw may be in the range of about 20 to 300 μm. In the exemplary embodiment, in order to achieve an arrangement pitch of 100 μm of the waveguide cores 12, a blade having a thickness of 50 μm may be used.

In the cutting with a dicing saw, since a blade of the dicing saw is tapered, shapes of the waveguide cores 12 formed and arranged may differ in the thickness direction of the polymer film 10A (optical waveguide film 10). That is, while, ideally, the dicing saw cuts grooves vertical with respect to the film surface, in actuality, an angle error is generated on vertical surfaces of the grooves.

Accordingly, even when the pitches of the waveguide cores 12 are constant between the waveguide cores 12 arranged in the thickness direction of the polymer film 10A, the widths of the waveguide cores 12 arranged in the thickness direction of the polymer film 10A are different from each other. Specifically, a width of a waveguide core 12 on a cutting side of the polymer film 10A is smaller than a width of a waveguide core 12 on a side opposite thereto (a side of the first clad layer 14). When an error of, for instance, 20% or more is generated in a diameter of the waveguide core 12, a nonnegligible adverse effect may be caused on the connection with an optical fiber, or a light receiving or emitting element.

When a vertical processing angle error with respect to a surface of a polymer film 10A in the cutting with the dicing saw is represented by θ (rad); a thickness of a polymer film 10A (laminated body) is represented by t (μm); and a design value of a diameter of a waveguide core 12 is represented by D (μm), in considering the possibility that both sides of the core are affected by the processing error, the cutting with the dicing saw may be carried out so as to satisfy a formula: θ≦0.1 (D/t) (rad). Thereby, a width error between waveguide cores 12 arranged in a thickness direction of the polymer film 10A (optical waveguide film 10) may be suppressed to realize excellent connection with an optical fiber, or a light receiving or emitting element.

Here, a vertical processing angle error θ with respect to a surface of a polymer film 10A (surface of a laminated body) means an angle (acute angle) between a side face of a blade of the dicing saw and a normal line that is orthogonal to the surface of the polymer film 10A.

In the above formula, for instance, when a thickness of the polymer film 10A (laminated body), t, is set to 400 μm and a design value of a diameter of the waveguide core 12, D, is set to 50 μm, θ≦0.0125 rad is obtained. In order to achieve the vertical processing angle error θ of this value, for instance, a dicing saw (trade name: DAD321, manufactured by Disco Corporation) provided with a dedicated dicing blade may be utilized. When, in the dicing saw (trade name: DAD321, manufactured by Disco Corporation), a blade having a width in the range of about 20 to 200 μm is used to form grooves, the vertical processing angle error θ may be suppressed to about 0.005 rad.

However, from the processing accuracy of the dicing saw, when a total thickness of the polymer film 10A (optical waveguide film 10) is for instance 1 mm or more, in some cases, an error of diameters between the waveguide cores 12 arranged in a thickness direction of the polymer film 10A may not be suppressed within an allowable range. In this case, the width of a waveguide core 12 portion is about 50 μm but the height is 1 mm or more, and the aspect ratio exceeds 20; accordingly, the waveguide core portion may be cut off during the processing, or, owing to large fluctuation, side faces of the waveguide core 12 (both end faces in a film width direction) may be roughened to result in poor yield. On the other hand, when a total thickness of the polymer film 10A (optical waveguide film 10) is 0.1 mm or less, even when a diameter of the waveguide core 12 is set at, for instance, 45 μm, a clad thickness is about 5 μm; accordingly, in some cases, excellent cutting may not be realized. Accordingly, when a waveguide core 12 is formed by the cutting with the dicing saw, a thickness of the polymer film 10A (laminated body) may be 0.1 mm to 1 mm (specifically, 0.15 mm to 0.8 mm).

Furthermore, when it is required that the optical waveguide has flexibility, the optical waveguide film 10 may have a thickness of 0.5 mm or less and specifically of 0.2 mm or less. In order that easy handling and twisting property are simultaneously satisfied, the optical waveguide film 10 may have a width of 0.1 mm to 10 mm and specifically a width of 0.5 mm to 3 mm. When the thickness and the width of the optical waveguide film 10 are set in the above ranges, twisting and bending flexibility may be secured as shown in FIGS. 3A to 3B, and the strength may be obtained.

When the dicing saw processing is difficult due to the material or the thickness of the polymer film 10A (laminated body), means such as reactive ion etching or excimer laser may be used.

In the next place, as shown in FIG. 4C, a third clad layer forming curable resin is filled in grooves 20 formed in the polymer film 10A and cured to form a third clad layer 18A corresponding to a third clad 18. Furthermore, in the exemplary embodiment, the third clad layer forming curable resin is filled in the grooves 20, and simultaneously coated on a surface (exposed surface) of the core layer 12A (waveguide core 12) positioned at the uppermost layer (layer located on a side opposite to the first clad layer in a film thickness direction) of the polymer film 10A to form a third clad layer 18A.

Here, a curable resin for forming the third clad layer 18A is a liquid material and a material such as a radiation-curable, EB-curable or thermosetting resin is used. Specifically, as the curable resin, a UV-curable resin and thermosetting resin may be used and more specifically a UV-curable resin may be selected. As the UV-curable resin or the thermosetting resin, a UV-curable or thermosetting monomer, oligomer or a mixture of the monomer and oligomer may be used. As the UV-curable resin, an epoxy type, polyimide type or an acryl type UV-curable resin may be used.

The refractive index difference of the respective clad layers may be small in consideration of the confinement of light, and may be 0.01 or less, specifically 0.001 or less, and more specifically 0.

Thus, an optical waveguide film 10 is prepared.

In the optical waveguide film 10 according to the above-described exemplary embodiment, the polymer film 10A in which the core layers 12A and the clad layers (the first clad layer 14A and the second clad layers 16A) are alternately laminated is cut to form waveguide cores having a three-dimensional structure (three-dimensionally arranged structure). Since the convenient method of cutting is used and the waveguide cores 12 are formed by cutting the core layers and the second clad layers alternately laminated on the first clad layer (the lowermost clad layer), accordingly, the positional deviation between a plurality of the three-dimensionally structured waveguide cores (namely, the pitch error) is suppressed to lower the defect rate, whereby an optical waveguide having a three-dimensional structure may be obtained with excellent productivity.

### EXAMPLES

In what follows, the present invention will be specifically described with reference to examples. However, the examples do not restrict the invention.

### Example 1

According to the production method of the optical waveguide film according to the above-mentioned exemplary embodiment, an optical waveguide film is prepared as shown below.

In the beginning, four layers of each of a clad layer made of an acrylic polymer and having a refractive index of 1.51 and a thickness of 75 μm and a core layer made of an acrylic polymer and having a refractive index of 1.55 and a thickness of 50 μm, in total eight layers, are alternately laminated to prepare a laminated polymer film having a thickness of 500 μm. Then, a dicing tape is adhered to the laminated polymer film so that a clad layer side of the laminated polymer film may be a lower side.

Subsequently, a dicing blade having a width of 50 μm is attached to a dicing saw (trade name: DAD321, manufactured by Disco Corporation) and the laminated polymer film is cut at a depth of 425 μm and a pitch of 125 μm at five positions to form five grooves in a film width direction along a length direction of the film. Thereby, waveguide cores having a diameter of 50 μm (design value: 50 μm in both width and thickness) are formed so as to be arranged in a 4×4 array (lattice). Here, a groove width actually processed here is 51 μm at the deepest portion and 53 μm at an upper portion side of the film (film-cutting surface side) and the vertical processing angle error θ with respect to a film surface is 0.005 rad. Here, 0.1 (D/t)=0.1 (50/500)=0.01.

In the next place, a UV-curable acrylic resin having a refractive index of 1.51 and a viscosity of 500 cPs (manufactured by JSR Corporation) is coated on the laminated polymer film to fill the curable resin in the grooves formed in the film and cover the film surface with the curable resin. Then, to the curable resin, under a nitrogen atmosphere, UV-ray having a wavelength of 365 nm and an intensity of 50 mW/cm² is illuminated for 2 min, whereby the curable resin is cured and a clad layer is formed.

Thus, an embedded laminated waveguide film having a total thickness of 575 μm is completed. The dicing saw is used to carry out external cutting and thereby an optical waveguide film having a three-dimensional structure where waveguide cores are arranged in array at a pitch of 125 μm in an up and down direction (film thickness direction) and a horizontal direction (film width direction) is completed.

The completed optical waveguide film has a waveguide core width of 46 μm to 48 μm, and the connection loss with a graded index (GI) multi-mode fiber having an aperture of 50 μm is 0.3 dB at the maximum, which is excellent. Furthermore, the optical waveguide film, since the pitch error of the waveguide cores is about 2 μm at the maximum, is excellent in the connection property with a half-pitch fiber array or a light receiving or emitting element.

### Example 2

According to the production method of an optical waveguide film according to the above-mentioned exemplary embodiment, an optical waveguide film is prepared as shown below.

In the beginning, four layers of each of a clad layer made of an acrylic polymer and having a refractive index of 1.51 and a core layer made of an acrylic polymer and having a refractive index of 1.55 and a thickness of 50 μm, in total eight layers, are alternately laminated to prepare a laminated polymer film having a thickness of 850 μm. Here, a clad layer thickness is set at 50 μm for the lowermost layer (layer located on a side opposite to a cutting surface) and at 200 μm for layers other than the layer. Then, a dicing tape is adhered to the laminated polymer film so that a clad layer side of the laminated polymer film may be a lower side.

Subsequently, a dicing blade having a width of 198 μm is attached to a dicing saw (trade name: DAD321, manufactured by Disco Corporation) and the laminated polymer film is cut at a depth of 800 μm and a pitch of 250 μm at five positions to form five grooves in a film width direction along a length direction of the film. Thereby, waveguide cores having a diameter of 50 μm (design value: 50 μm in both width and thickness) are formed so as to be arranged in a 4×4 array (lattice). Here, a groove width actually processed here is 48 μm at the deepest portion and 53 μm at an upper portion side of the film (film-cutting surface side) and the vertical processing angle error θ with respect to a film surface is 0.005 rad. Here, 0.1 (D/t)=0.1 (50/850)=0.00588.

In the next place, an acrylic UV-curable resin having a refractive index of 1.51 and a viscosity of 500 cPs (manufactured by JSR Corporation) is coated on the laminated polymer film to fill the curable resin in the grooves formed in the film and cover the film surface with the curable resin. Then, to the curable resin, under a nitrogen atmosphere, UV-ray having a wavelength of 365 nm and an intensity of 50 mW/cm² is illuminated for 2 min, whereby the curable resin is cured and a clad layer is formed.

Thus, an embedded laminated waveguide film having a total thickness of 900 μm is completed. The dicing saw is used to carry out external cutting and thereby an optical waveguide film having a three-dimensional structure where waveguide cores are arranged in array at a pitch of 250 μm in an up and down direction (film thickness direction) and a horizontal direction (film width direction) is completed.

The completed optical waveguide film has a waveguide core width of 46 μm to 52 μm, and the connection loss with a graded index (GI) multi-mode fiber having an aperture of 50 μm is 0.4 dB at the maximum, which is excellent. Furthermore, the optical waveguide film, since the pitch error of the waveguide cores is about 2 μm at the maximum, is excellent in the connection property with a half-pitch fiber array or a light receiving or emitting element.

### Example 3

According to a production method of an optical waveguide film according to the above-mentioned exemplary embodiment, an optical waveguide film is prepared as shown below.

In the beginning, two layers of each of a clad layer made of an acrylic polymer and having a refractive index of 1.51 and a thickness of 25 μm and a core layer having a refractive index of 1.55 and a thickness of 50 μm, in total four layers, are alternately laminated to prepare a laminated polymer film having a thickness of 150 μm. Then, a dicing tape is adhered to the laminated polymer film so that a clad layer side of the laminated polymer film may be a lower side.

Subsequently, a dicing blade having a width of 50 μm is attached to a dicing saw (trade name: DAD321, manufactured by Disco Corporation) and the laminated polymer film is cut at a depth of 125 μm and a pitch of 75 μm at five positions to form five grooves in a film width direction along a length direction of the film. Thereby, waveguide cores having a diameter of 50 μm (design value: 50 μm in both width and thickness) are formed so as to be arranged in a 4×2 array (lattice). Here, a groove width actually processed here is 50.5 μm at the deepest portion and 52 μm at an upper portion side of the film (film-cutting surface side) and the vertical processing angle error θ with respect to a film surface is 0.005 rad. Here, 0.1 (D/t)=0.1 (50/150)=0.03333.

In the next place, a UV-curable acrylic resin having a refractive index of 1.51 and a viscosity of 500 cPs (manufactured by JSR Corporation) is coated on the laminated polymer film to fill the curable resin in the grooves formed in the film and cover the film surface with a curable resin. Then, to the curable resin, under a nitrogen atmosphere, UV-ray having a wavelength at 365 nm and an intensity of 50 mW/cm² is illuminated for 2 min, whereby the curable resin is cured and a clad layer is formed.

Thus, an embedded laminated waveguide film having a total thickness of 175 μm is completed. The dicing saw is used to carry out external cutting and thereby an optical waveguide film having a three-dimensional structure where waveguide cores are arranged in array at a pitch of 75 μm in an up and down direction (film thickness direction) and a horizontal direction (film width direction) is completed.

The completed optical waveguide film has a waveguide core width of 48 μm to 50 μm, and the connection loss with a graded index (GI) multi-mode fiber having an aperture of 50 μm is 0.3 dB at the maximum, which is excellent. Furthermore, the optical waveguide film, since the pitch error of the waveguide cores is about 2 μm at the maximum, is excellent in the connection property with a half-pitch fiber array or a light receiving or emitting element. Still furthermore, the completed optical waveguide film has flexibility capable of bending at a curvature radius of 3 mm without destroying.

### Example 4

According to a production method of an optical waveguide film according to the above-mentioned exemplary embodiment, an optical waveguide film is prepared as shown below.

In the beginning, six layers of each of a clad layer made of an acrylic polymer and having a refractive index of 1.51 and a core layer made of an acrylic polymer and having a refractive index of 1.55 and a thickness of 50 μm, in total twelve layers, are alternately laminated to prepare a laminated polymer film having a thickness of 1350 μm. Here, a thickness of the clad layer is set at 50 μm for the lowermost layer (layer located on a side opposite to a cutting surface) and at 200 μm for layers other than the layer. Then, a dicing tape is adhered to the laminated polymer film so that a clad layer side of the laminated polymer film may be a lower side.

Subsequently, a dicing blade having a width of 198 μm is attached to a dicing saw (trade name: DAD321, manufactured by Disco Corporation) and the laminated polymer film is cut at a depth of 1300 μm and a pitch of 198 μm at seven positions to form seven grooves in a film width direction along a length direction of the film. Thereby, waveguide cores having a diameter of 50 μm (design value: 50 μm in both width and thickness) are formed so as to be arranged in a 6×6 array (lattice). Here, a groove width actually processed is 199 μm at the deepest portion and 215 μm at an upper portion side of the film (film-cutting surface side), and a small part of the waveguide cores is cut off The vertical processing angle error θ with respect to a film surface is 0.005 rad. Here, since 0.1 (D/t)=0.1 (50/1350)=0.0037 and the vertical processing error is larger than this value, due to the core diameter error, the connection loss may be a little bit increased.

In the next place, a UV-curable acrylic resin having a refractive index of 1.51 and a viscosity of 500 cPs (manufactured by JSR Corporation) is coated on the laminated polymer film to fill the curable resin in the grooves formed in the film and cover the film surface with the curable resin. Then, to the curable resin, under a nitrogen atmosphere, UV-ray having a wavelength of 365 nm and an intensity of 50 mW/cm² is illuminated for 2 min, whereby the curable resin is cured and a clad layer is formed.

Thus, an embedded laminated waveguide film having a total thickness of 1499 μm is completed. The dicing saw is used to carry out external cutting and thereby an optical waveguide film having a three-dimensional structure where waveguide cores are arranged in array at a pitch of 198 μm in both of an up and down direction (film thickness direction) and a horizontal direction (film width direction) is completed.

The completed optical waveguide film has a waveguide core width of 35 μm to 52 μm and the connection loss with a graded index (GI) multi-mode fiber having an aperture of 50 μm is 1.2 dB at the maximum, that is, the loss is increased a little.

What is claimed is:

1. A production method of an optical waveguide, comprising:
preparing a laminated body that comprises a first clad layer and, on the first clad layer, a core layer and a second clad layer alternately laminated in this order so that two or more of the core layer are comprised in the laminated body;
forming a light-propagating waveguide core by cutting the laminated body so as to reach but not cut through the first clad layer from a side where the core layer and the second clad layer are laminated; and
embedding at least a cut portion of the laminated body with a third clad layer.

2. The production method of an optical waveguide according to claim 1, wherein the laminated body is cut by use of a dicing saw.

3. The production method of an optical waveguide according to claim 2, wherein the cutting of the laminated body by use of a dicing saw is performed so that the formula: θ≦0.1 (D/t) (rad) is satisfied, wherein θ (rad) is a vertical processing angle error with respect to a surface of the laminated body in the cutting, t (μm) is a thickness of the laminated body, and D (μm) is a design value of a diameter of the waveguide core.

4. The production method of an optical waveguide according to claim 1, wherein the embedding at least a cut portion of the laminated body with a third clad layer comprises filling a curable resin in the cut portion of the laminated body and curing the curable resin.

5. The production method of an optical waveguide according to claim 4, wherein the curable resin is a UV-curable resin.

6. The production method of an optical waveguide according to claim 1, wherein the laminated body comprises an alicyclic olefin film, an acrylic film, an epoxy film, or a polyimide film.

7. The production method of an optical waveguide according to claim 1, wherein a thickness of the laminated body is about 0.1 mm to 1 mm.

8. The production method of an optical waveguide according to claim 1, wherein a thickness of the laminated body is about 0.15 mm to 0.8 mm.
